(19) United States
(12) Patent Application Publication
(10) Pub. No.: US 2020/0004946 A1
(43) Pub. Date: Jan. 2, 2020

(54) Secretless and secure authentication of network resources

(71) Applicant: CyberArk Software Ltd., Petach-Tikva (IL)

(72) Inventors: Kevin Gilpin, Weston, MA (US); Elizabeth Lawler, Weston, MA (US); Dustin Byrne, Haverhill, MA (US)

(73) Assignee: CyberArk Software Ltd., Petach-Tikva (IL)

(21) Appl. No.: 15/998,492

(22) Filed: Aug. 16, 2018

Related U.S. Application Data
(60) Provisional application No. 62/693,061, filed on Jul. 2, 2018.

(51) Int. Cl. G06F 21/33; H04L 29/06; H04L 9/32

(52) U.S. Cl. CPC G06F 21/335; H04L 63/0884; H04L 9/3213; H04L 63/0428; H04L 63/10

(57) ABSTRACT

Disclosed embodiments relate to secretless and secure communications with access-protected network resources. Techniques include identifying a request from a client service to access an access-protected network resource; automatically identifying an identity token uniquely associated with the client service for enabling autonomous authentication of the client service using the identity token; providing, from a secretless connection broker to an authentication credential provider, the identity token uniquely associated with the client service; receiving, from the authentication credential provider, based on the identity token and conditional on successful authentication of the client service, a connection credential; establishing a secure connection with the access-protected network resource using the connection credential; and exchanging secure communications with the access-protected network resource.

### CROSS-REFERENCE TO RELATED APPLICATION

The present application claims the benefits of priority to U.S. Provisional Application No. 62/693,061, titled “Secretless,” filed on Jul. 2, 2018, the entire contents of which are hereby incorporated by reference.

### BACKGROUND

Many networks implement credential requirements for users to access restricted resources. For example, a password, token, certificate, or other privileged data may be needed for users to authenticate themselves and thereby gain access to sensitive resources such as code repositories, cloud-orchestration environments, secure servers, or sensitive databases. But the use of credentials introduces security problems, performance limitations, and usability degradations.

For example, in environments where user-supplied credentials are used for authentication, the loss or theft of such credentials can lead to security vulnerabilities. This may happen, for instance, when an application is checked into a source control system such that either the application and all of its contents, or at least a credential built into it, is stored in plaintext. An attacker with access to the source control system may thus steal the credential. Similarly, where a malicious user obtains a credential through an attack (e.g., a phishing attack, which may be followed by privilege escalation), the user may exploit the credential (and others they may steal) to expand their freedom of movement within a network. Indeed, credential theft is one of the most common, and damaging, attack vectors for organizations.

In response to these threats, some organizations implement credential rotation policies. Credentials for users, applications, and other resources may be replaced pursuant to a credential policy periodically or upon the detection of security events. But such credential rotation schemes also introduce problems. When credentials are rotated, users, applications, and other resources often suffer downtime, errors, and other performance problems when they are out of synch with the rotation and either lack current credentials or are attempting to communicate with other resources that lack current credentials.

Some organizations have attempted to maintain credentials in a secure, centralized location, such as a vault. Nevertheless, when a credential from the vault is checked out for a user, the credential may still be exposed to attackers. For example, the credential may be injected into an application, may be temporarily stored in memory on a client machine, or may be transmitted through insecure communications channels. Attackers may thus be able to intercept or steal the credential and use it for improper purposes.

Additional vulnerabilities and operational problems arise when organizations attempt to address credential security through piecemeal, uncoordinated techniques. When developers are faced with security requirements, they often adopt the least-friction solution for their particular needs with respect to the application they are developing. Such solutions are often different from application-to-application, at different times, and in different areas of a network. The result is a complex, sometimes contradictory, and largely unmanageable set of security requirements that still has exposure to credential-based attacks and is unwieldy for administrators to oversee. In such disorderly security approaches, organizations cannot implement a comprehensive credential-management regime and cannot achieve significant protection against credential-based attacks.

Accordingly, in view of these and other deficiencies in existing techniques, technological solutions are needed for controlling the use of credentials in network environments. For example, solutions are needed for controlling the use of credentials in applications that have been compromised by attackers. Solutions are also needed to address to problem of migrating off of one secrets management platform and on to another. Advantageously, the solution should be secretless, in the sense that a client service requesting and receiving access to a target service need not possess or present credentials itself. Further, the solution should be autonomous and transparent from the perspective of the requesting client application and the target resource.

### SUMMARY

The disclosed embodiments describe non-transitory computer readable media, systems, and methods for secretless and secure communications with access-protected network resources. For example, in an exemplary embodiment, there may be a non-transitory computer readable medium including instructions that, when executed by at least one processor, cause the at least one processor to perform operations for secretless and secure communications with access-protected network resources. The operations may comprise identifying, at a secretless connection broker, a request from a client service to access an access-protected network resource, wherein the client service lacks information required for a connection with the access-protected network resource; automatically identifying, based on the request, an identity token uniquely associated with the client service for enabling autonomous authentication of the client service using the identity token; providing, from the secretless connection broker to an authentication credential provider, the identity token uniquely associated with the client service; receiving, from the authentication credential provider, based on the identity token and conditional on successful authentication of the client service, a connection credential for enabling the secretless connection broker to connect with the access-protected network resource on behalf of the client service as specified in the request, wherein the connection credential is not made accessible to the client service; establishing a secure connection, on behalf of the client service, with the access-protected network resource using the connection credential; and exchanging secure communications, on behalf of the client service, with the access-protected network resource through the secure connection.

According to a disclosed embodiment, the secretless connection broker is configured to receive, from the client service, configuration information.

According to a disclosed embodiment, the configuration information includes an identification of the access-protected network resource.

According to a disclosed embodiment, the configuration information identifies a connection listener for the secretless connection broker to establish.

According to a disclosed embodiment, the configuration information identifies the connection credential.

According to a disclosed embodiment, the secretless connection broker is configured to receive, from the client service, configuration information specifying one or more attributes of the secure connection with the access-protected network resource.

According to a disclosed embodiment, the secretless connection broker is configured to establish the secure connection with the access-protected network resource only when the client service is communicating with the secretless connection broker from an approved domain.

According to a disclosed embodiment, the secretless connection broker is configured to intercept outgoing communications from the client service.

According to a disclosed embodiment, the secretless connection broker is configured to control the exchanged secure communications with the access-protected network resource.

According to a disclosed embodiment, the secretless connection broker exchanges the secure communications with the access-protected network resource transparently to the client service.

According to a disclosed embodiment, the authentication credential provider is configured to rotate the connection credential to a new connection credential, and the secretless connection broker is configured to receive the new connection credential.

According to a disclosed embodiment, the authentication credential provider is configured to rotate the connection credential each time the client service requests access to the access-protected network resource.

According to a disclosed embodiment, the secretless connection broker is configured to pass through communications from the client service addressed to a network resource other than the access-protected network resource.

According to a disclosed embodiment, once the secretless connection broker establishes the secure connection with the access-protected network resource, the secretless connection broker does not receive the secure communications with the access-protected network resource.

According to a disclosed embodiment, the client service has a plurality of constituent identities, and the secretless connection broker is dedicated to a specific identity from the plurality of constituent identities.

According to a disclosed embodiment, the plurality of constituent identities are each associated with a different secretless connection broker from a plurality of secretless connection brokers.

According to a disclosed embodiment, the secretless connection broker is automatically terminated upon termination of the client service.

According to a disclosed embodiment, the connection credential is a one-time-use connection credential uniquely associated with the access request from the client service and the access-protected network resource.

According to a disclosed embodiment, exchanging secure communications includes routing communications between the client service and the access-protected network resource.

According to a disclosed embodiment, exchanging secure communications includes setting up a secure tunnel between the client service and the access-protected network resource.

According to another disclosed embodiment, a method may be implemented for secretless and secure communications with access-protected network resources. The method may comprise identifying, at a secretless connection broker, a request from a client service to access an access-protected network resource, wherein the client service lacks information required for a connection with the access-protected network resource; automatically identifying, based on the request, an identity token uniquely associated with the client service for enabling autonomous authentication of the client service using the identity token; providing, from the secretless connection broker to an authentication credential provider, the identity token uniquely associated with the client service; receiving, from the authentication credential provider, based on the identity token and conditional on successful authentication of the client service, a connection credential for enabling the secretless connection broker to connect with the access-protected network resource on behalf of the client service as specified in the request, wherein the connection credential is not made accessible to the client service; establishing a secure connection, on behalf of the client service, with the access-protected network resource using the connection credential; and exchanging secure communications, on behalf of the client service, with the access-protected network resource through the secure connection.

According to another disclosed embodiment, the secretless connection broker is an agent running on the same machine as the client service.

According to another disclosed embodiment, the secretless connection broker is a proxy server located remote from the client service.

According to another disclosed embodiment, the secretless connection broker is configured to open a local connection with an application associated with the client service.

According to another disclosed embodiment, the identity token is securely stored on the secretless connection broker.

According to another disclosed embodiment, the secretless connection broker is configured to store a plurality of different identity tokens for use in authenticating the client service to a plurality of different authentication credential providers.

According to another disclosed embodiment, the plurality of different identity tokens are stored on a secure keyring of the secretless connection broker.

According to another disclosed embodiment, the method further comprises providing, from the secretless connection broker to the authentication credential provider, additional authentication information for enabling authentication of the client service by the authentication credential provider.

According to another disclosed embodiment, the method further comprises providing the connection credential to the access-protected network resource to establish the secure connection.

According to another disclosed embodiment, the method further comprises requesting that the authentication credential provider rotate the connection credential upon the termination of the secure connection.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an example system for secretless and secure communications with access-protected network resources, in accordance with disclosed embodiments.

FIG. 2 is another block diagram of an example system for secretless and secure communications with access-protected network resources, in accordance with disclosed embodiments.

FIG. 3 is an illustration of exemplary relationships between client services and brokers, in accordance with disclosed embodiments.

FIG. 4 is a flowchart illustrating a process of secretless and secure communications with access-protected network resources, in accordance with disclosed embodiments.

FIG. 5 is another flowchart illustrating a process of secretless and secure communications with access-protected network resources, in accordance with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for secretless and secure communications described herein overcome various deficiencies in prior security approaches. According to disclosed embodiments, a client service can obtain access to an access-protected network resource without having to locally store, obtain, or provide a credential for such access. Consequently, if the client service is later compromised (e.g., published publicly, infected by malware, controlled by an attacker, etc.), the dangers of password theft will be controlled. In such situations, an attacker will not be able to steal a password associated with the client service or improperly escalate their privileges in a network.

Reference will now be made in detail to the disclosed embodiments, examples of which are illustrated in the accompanying drawings.

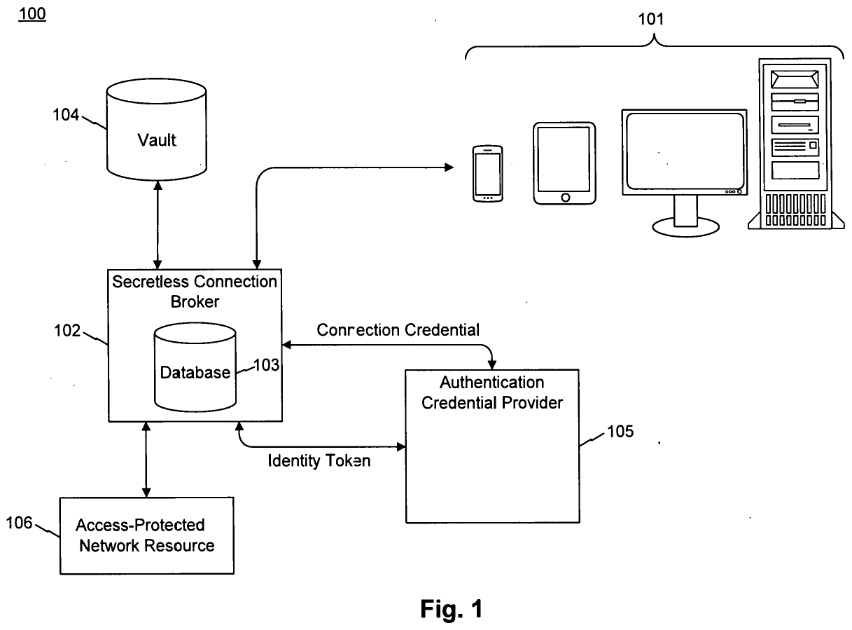

FIG. 1 is a block diagram of an example system 100 for secretless and secure communications consistent with disclosed embodiments. As shown, system 100 includes a plurality of client services 101 that may communicate through a network with one or more access-protected network resources 106.

Client services 101 may be a variety of different types of applications or computing devices with network communications capabilities. For example, client services 101 may be accounts established according to a particular operating system (e.g., MICROSOFT WINDOWS accounts, APPLE IOS accounts, UNIX/LINUX accounts, etc.) or particular applications (e.g., an Internet browser, business application, engineering application, social networking application, etc.). Client services 101 may also be virtualized instances of applications, such as virtual machines, container instances, serverless code instances, etc. Further, client services 101 may be personal computers, laptops, mobile computing devices (e.g., smartphones), tablets, IoT devices, wearable computer devices (e.g., smart clothing, smart watches, smart jewelry, etc.), automotive computer devices, smart home appliances, etc. As discussed further below, such client services 101 may include hardware processors and memories for storing data and/or software instructions, as well as communications interfaces for exchanging data with remote servers (e.g., access-protected network resource 106).

Access-protected network resource 106 may be any type of network device, application, or system that requires authentication for a client service 101 to access it or its contents. Examples of access-protected network resource 106 include a secure virtualization platform orchestrator tool, a secure database, a source code control repository, an application running on a secure server or as a virtualized process, and various other types of controlled network resources. As additional examples, access-protected network resource 106 may be a virtualized instance of an application running in a cloud-computing environment, such as a cloud platform based on AMAZON AWS, MICROSOFT AZURE, GOOGLE CLOUD PLATFORM, IBM CLOUD, or similar systems. As other another example, an access-protected network resource 106 may be a corporate database storing financial or engineering data, which has access restrictions that limit access to a defined group of users. Further, access-protected network resource 106 may be a server hosting user accounts, such as a FACEBOOK server, TWITTER server, GMAIL server, etc. Various other types of access-protected network resources 106 are possible as well. Access to access-protected target resource 106 may be controlled, at least in part, through a requirement that client services 101 authenticate themselves (e.g., authenticate a user, an application, a machine, etc.) before gaining access to access-protected target resource 106. In some embodiments, as discussed below, a connection credential may be required for a client service 101 to gain access to the access-protected target resource 106.

Client services 101 may communicate with access-protected network resource 106, and also with secretless connection broker 102, via a network. The network may be based on any type of computer networking arrangement used to exchange data, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile network, a private data network, a virtual private network using a public network, a nearfield communications technique (e.g., Bluetooth, infrared, etc.) that enables client services 101 to send and receive information with other components in system 100. In some embodiments, the network may include two or more of these forms of communications.

One or more secretless connection brokers 102 may be configured to allow client services 101 to connect to access-protected network resources 106 without client services 101 having to store or provide connection credentials or other secrets. As discussed in greater detail below, brokers 102 may identify requests from client services 101 that seek access to access-protected network resources 106, and establish secure communications on behalf of client services 101. For example, as discussed further below, brokers 102 may identify an identity token uniquely associated with a client service 101 (e.g., stored in a database 103 or separately at a vault 104), and may present the identity token to an authentication credential provider 105. The authentication credential provider 105 may, upon verification of the identity token or authentication of the client service 101, supply a connection credential to the broker 102. The broker 102 may then use the connection credential to establish a secure communication connection with the target access-protected network resource 106 on behalf of the client service 101. In such embodiments, the client service 101 need not store or provide the connection credential itself. Further, in some embodiments, the client service 101 also need not store or provide the identity token, although in other embodiments the identity token is stored and provided by the client service 101. Consistent with disclosed embodiments, brokers 102 can facilitate connections with a variety of different target access-protected network resource 106 technologies, such as HTTP (e.g., via an authorization header), SSH (e.g., via man-in-the-middle (MITM) or via an SSH agent), or various different database protocols (e.g., ORACLE, PostgreSQL, MySQL, NoSQL, etc.).

In some embodiments, brokers 102 may also receive configuration information from client services 101, which brokers 102 may store (e.g., in database 103) as part of a configuration file. For example, the configuration information may include an identification (e.g., by IP address, network resource name, unique identifier, etc.) of an access-protected network resource 106 to which the client service 101 seeks access. Further, the configuration information may identify a connection listener that the broker 102 can establish. A listener, for example, can define the information needed (e.g., particular host, port, and connection protocol) for the client service 101 to connect and authenticate to a particular access-protected network resource 106. In some embodiments, when a listener receives a connection request from a client service 101, it invokes a configured handler, which may be an open, extensible driver model that enables the client service 101 to understand native protocols (e.g., databases, HTTP(S), SSH, etc.) and communicate with various different technologies at access-protected network resources 106. In addition, the client service 101 may send to the broker 102 various types of environment variables (e.g., files running, operating system running, application update status, user logged in, connection history, etc.), which the broker 102 may also store in the configuration file. Further, in some embodiments, the configuration information stored by broker 102 may specifically identify the required connection credential (e.g., by an IP address where it is stored, by a network resource name, by file path, by virtualized environment storage location, etc.) for establishing a secure connection between the client service 101 and an access-protected network resource 106. In addition, in further embodiments, the configuration information provided by the client service 101 specifies one or more attributes of a secure connection that should be established between it and the access-protected network resource 106. For example, the configuration information may indicate whether the secure connection should be based on SSL, TLS, a secure shell tunnel, an IPIP tunnel, an IPSec tunnel, or a different secure connection protocol.

In some embodiments, a vault 104 may be configured to store identity tokens associated with one or many different client services 101. Identity tokens may uniquely identify users, applications, or devices associated with client services 101. For example, identity tokens may specify a particular user's name or identifier, an application name or identifier, a set of privileges (e.g., access rights), address information (e.g., an IP address, MAC address, etc.), expiration date or time information, etc. In some embodiments, the identity tokens are also associated with particular access-protected network resources 106. For example, the identity token associated with a particular user of a client service 101 may specify that the individual has access to an ORACLE database but lacks access to a web development server. Further, the identity token associated with an application of a client service 101 may specify that the application only has access to a particular virtualized application instance, and that such access rights expire in 30 days.

As illustrated in FIG. 1, database 103 and/or vault 104 may be used for storing identity tokens and configuration files. For example, identity tokens may be stored within an operating system keyring on secretless connection broker 102. In some embodiments, where secretless connection broker 102 obtains identity tokens from vault 104, it caches the identity tokens locally in database 103. Further, in some embodiments, secretless connection broker 102 is required to authenticate itself to vault 104 before being able to obtain identity tokens from vault 104. As one example of such authentication, secretless connection broker 102 may communicate with vault 104 in a Kubernetes-based framework, where secretless connection broker 102 must provide an access token (e.g., time-limited token, one-time-use token, etc.) to vault 104 for authentication. Of course, secretless connection broker 102 may authenticate itself to vault 104 in other ways as well.

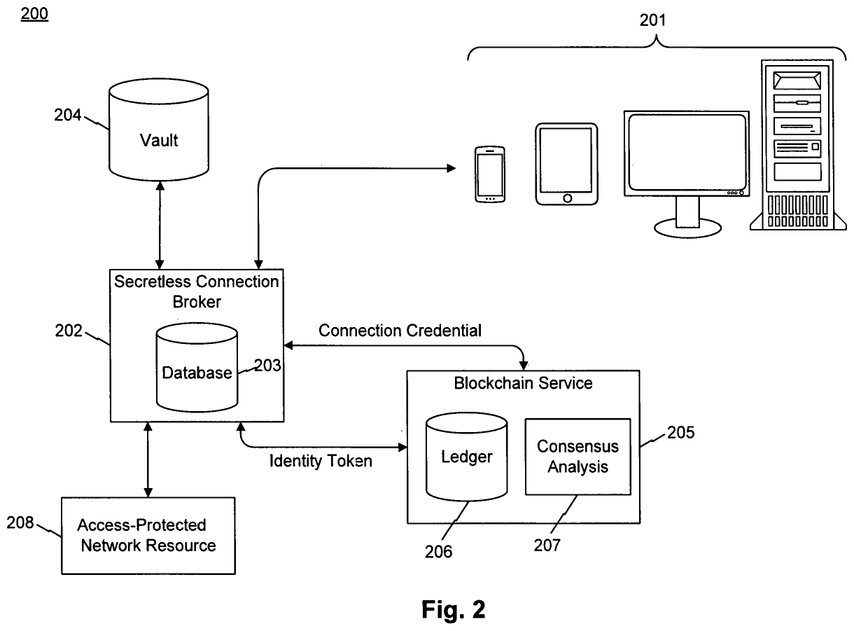

FIG. 2 is another block diagram of an example system 200 for secretless and secure communications with access-protected network resources. System 200 may be similar to system 100 in terms of client services 101/201, secretless connection broker 102/202, database 103/203, vault 104/204, and access-protected network resource 106/208. In addition, system 200 includes a blockchain authentication service 205, which may include an instance of a common ledger 206 and a consensus analysis system 207. Blockchain authentication service 205 may be used instead of, or as an added layer of authentication to, authentication credential provider 105.

For example, in some embodiments client services 201 may each register themselves in a blockchain network in which they participate. Each client service 201 may have a registered identity in the blockchain network, which may be based on information such as a user's name or identifier, an application name or identifier, address information (e.g., an IP address, MAC address, etc.), or other identifying information. Each time a client service 201 engages in a network transaction (e.g., logs into a machine, enters a local password to access a local operating system or application, authenticates itself to a remote server, downloads files, installs a software upgrade, participates in a continuous deployment practice, etc.), the transaction may be recorded in a shared ledger with information regarding the transaction and the identity of the client service 201. For example, transaction records may be created or updated upon each relevant transaction involving a client service, regardless of whether the transaction is successful or unsuccessful (e.g., regardless of whether the user is able to log in to a local operating system).

As shown in system 200, blockchain service 205 may include a ledger 206 which is an instance of the shared ledger created based on the transactions involving client services 201. When a client service 201 seeks to communicate with an access-protected network resource 208, an authentication process performed by consensus analysis system 207 may be performed. For example, before an identity token is provided to secretless connection broker 202, or before a connection credential is provided to secretless connection broker 202, consensus analysis system 207 may authenticate the requesting client service 201. The authentication may involve analyzing the instance 206 of the shared ledger, which contains a transaction history involving the client service 201 (and possibly other client services or other identities). In some embodiments, the authentication may involve determining whether the requesting client service 201 was successful a threshold amount of the time (e.g., 90%, 99%, 99.99%, etc.) in its recorded transactions. If the threshold is met for the client service 201 based on its recorded transactions, consensus analysis system 207 may determine that an identity token (or connection credential) should be provided from blockchain service 205 to secretless connection broker 202 for client service 201. If the threshold is not met, blockchain service 205 may refuse to provide an identity token or connection credential. Of course, blockchain service 205 may perform various other types of blockchain-based authentication for client services 201 as well.

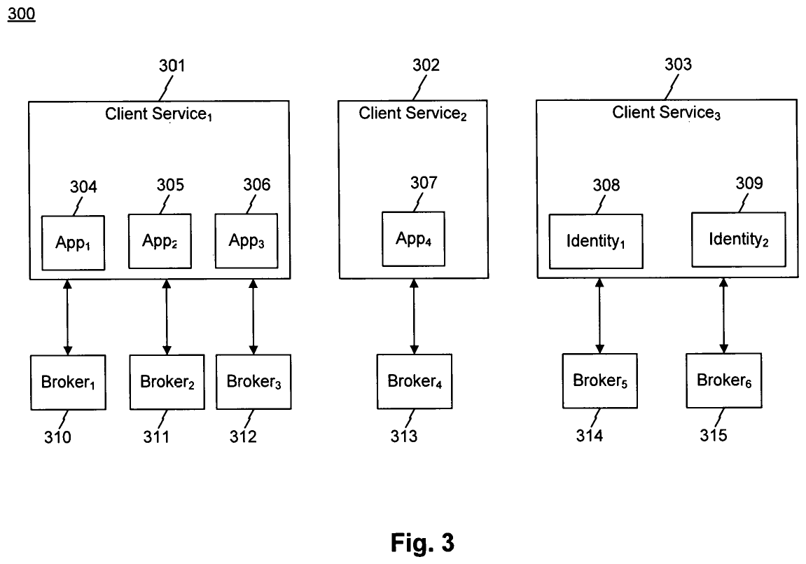

FIG. 3 is an illustration 300 of exemplary relationships between client services and brokers, in accordance with disclosed embodiments. As shown in FIG. 3, a network configuration may involve several client services 301-303, which may be various different users, applications, or devices, as discussed above in connection with client services 101/201. In the exemplary arrangement of FIG. 3, client service 301 has three different applications (304-306) for which secure connections (e.g., to access-protected network resource 106/208) are required. The applications 304-306 may be executing on client service 301 and require remote connections to access-protected network resources 106/208. Alternatively, the applications 304-306 may be represented on client service 301 as icons or graphics, such that the actual applications 304-306 execute remotely (e.g., at access-protected network resource 106/208). Client service 302 has one such application (307) requiring secure access to an access-protected resource, and client service 303 has two identities (308-309) that may engage in secure connections (e.g., to access-protected network resource 106/208). Identities 308-309 may be, for example, local operating system accounts on client service 303, network accounts, application accounts, virtualized application execution instances, etc.

In the embodiment illustrated in FIG. 3, each of the applications 304-306 associated with client service 301 may have a corresponding broker (310-312). In this way, for example, when client service 301 attempts to engage in a secure connection between application 304 and an access-protected network resource 106/208, broker 310 may facilitate the process by obtaining a required connection credential, as further discussed below. Alternatively, in embodiments where application 304 is an icon, and application 304 itself executes remotely, broker 310 may still facilitate the process of client service 301 communicating with the application 304 and obtaining a required connection credential on behalf of client service 301. Further, brokers 311 and 312 may be configured to provide secure communications between client service 301 for applications 305 and 306, respectively.

Similarly, when application 307 associated with client service 302 seeks to communicate with an access-protected network resource 106/208, broker 313 may facilitate the connection process, including fetching a required connection credential for use on behalf of client service 302. Further, when identity 308 seeks to communicate with an access-protected network resource 106/208, broker 314 may facilitate the connection, and when identity 309 seeks to communicate with an access-protected network resource 106/208, broker 315 may establish the appropriate communications connection, based on the techniques discussed below.

In the various embodiments depicted in FIG. 3, brokers 310-315 may be configured to access specific identity tokens corresponding to a particular application (304-309) seeking to participate in the secure communication with an access-protected network resource 106/208, corresponding to the particular client service 301-303, or both. As discussed above, the identity tokens may be obtained from database 103/203 and/or vault 104/204. Identity tokens obtained by secretless connection broker 102/202 may be cached locally in database 103/203.

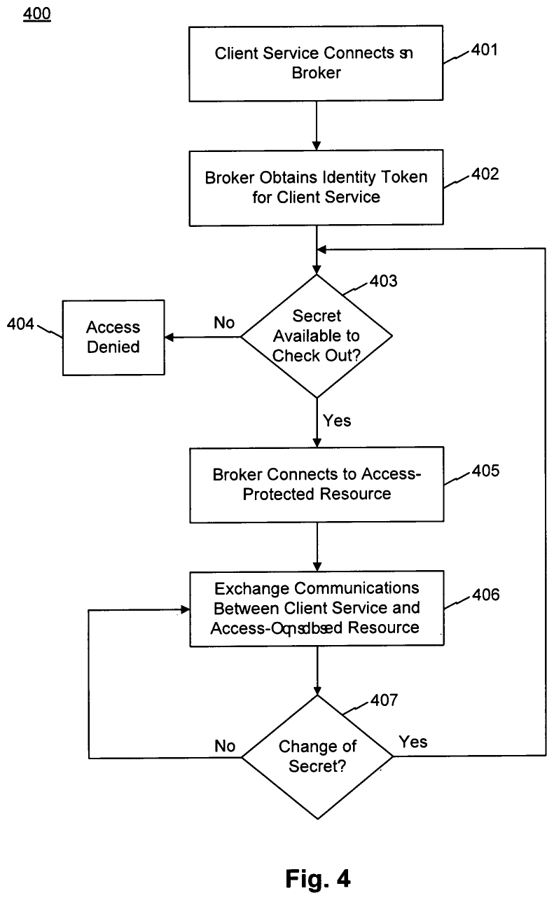

FIG. 4 is a flowchart illustrating a process 400 of secretless and secure communications with access-protected network resources. Consistent with above embodiments, process 400 may be performed by secretless connection broker 102/202 and/or other components of systems 100/200.

Process 400 may include an operation 401 of a client service 101/201 connecting to a secretless connection broker 102/202. Operation 401 may occur in a number of different ways. For example, client service 101/201 may send a request to log-in, to authenticate itself, or to communicate with a particular access-protected network resource 106/208. The request may be intercepted by secretless connection broker 102/202 (e.g., based on monitoring received communications), or rerouted to secretless connection broker 102/202 (e.g., through DNS resolution). Alternatively, client service 101/201 may directly seek to communicate with access-protected network resource 106/208, but may be rerouted to secretless connection broker 102/202 in order to undergo an authentication process before the client service 101/201 can actually communicate with access-protected network resource 106/208. In further embodiments, client service 101/201 may initially communicate with secretless connection broker 102/202 (e.g., through a portal established by secretless connection broker 102/202), and indicate to secretless connection broker 102/202 which particular access-protected network resource 106/208 it seeks to access. Further, consistent with above embodiments, operation 401 may include the client service 101/201 providing configuration information to sercretless connection broker 102/202 (e.g., indicating connection parameters, indicating a connection credential to fetch, etc.).

Process 400 may also include an operation 402 of the secretless connection broker 102/202 obtaining an identity token corresponding to the client service 101/201. As discussed above in connection with systems 100/200, for example, secretless connection broker 102/202 may request an identity token corresponding to a user, application, or device associated with client service 101/201 from authentication credential provider 105, blockchain service 205, or vault 104/204. The identity token may be unique to the client identity 101/201. For example, the identity token may be associated with, or identify, a name of a user, application, or device, an identifier of a user, application, or device, an IP address or MAC address of the client service 101/201, or other features of the client service 101/201. Further, as discussed above, in some embodiments the secretless connection broker 102/202 may have to authenticate itself to the authentication credential provider 105, blockchain service 205, or vault 104/204 before obtaining access to the appropriate identity token for a client service 101/201. In addition, in some embodiments, where secretless connection broker 102/202 has already received an cached the identity token (e.g., in database 103/203), it may be accessed from the database. Identity tokens that are obtained by a secretless connection broker 102/202 may, in some embodiments, be securely stored on an operating system keyring of the secretless connection broker 102/202. Further, in some embodiments, secretless connection broker 102/202 may utilize its configuration file to authenticate the client service 101/201 or to identify an appropriate connection credential.

Process 400 may also include an operation 403 of determining whether a secret (e.g., connection credential) is available to be accessed or checked out by secretless connection broker 102/202. The connection credential may be a secret (e.g., key, password, certificate, token, etc.) that is required for secure and authenticated access to a requested access-protected network resource 106/208. For example, if the access-protected network resource 106/208 is a secure database, the connection credential may be a password or key required to access or log-in to the database. The password or key (or other secret) may be withheld from client service 101/201. Accordingly, even if an attacker compromises client service 101/201, the attacker does not thereby gain access to the secret itself.

In some embodiments, operation 403 may involve comparing information from the identity token to a listing, mapping, or repository of connection credentials stored at authentication credential provider 105, blockchain service 205, or vault 104/204. In some embodiments, if the requesting client service 101/201 is not permitted to access the particular requested access-protected network resource 106/208, there may be no connection credential stored in the authentication credential provider 105, blockchain service 205, or vault 104/204. In that situation, process 400 may end in an operation 404, where no connection credential is made available to the secretless connection broker 102/202 and the client service 101/201 is not permitted to access the requested access-protected network resource 106/208. Alternatively, if there is a connection credential associated with the client service 101/201 stored in the authentication credential provider 105, blockchain service 205, or vault 104/204, the connection credential may be accessed or checked out by the secretless connection broker 102/202. For example, the connection credential may be transmitted to the secretless connection broker 102/202 in encrypted form. Alternatively, the connection credential is not provided directly to secretless connection broker 102/202, but instead the secretless connection broker 102/202 is permitted to instruct the access-protected network resource 106/208 that the necessary connection credential may fetched from credential provider 105, blockchain service 205, or vault 104/204. Further, in some embodiments, connection credentials do not necessarily exist at the time a request is received in operation 401. In such situations, secretless connection broker 102/202 may generate a connection credential on-demand, or may request the generation of a connection credential by credential provider 105, blockchain service 205, or vault 104/204.

In some embodiments, operation 403 further includes authenticating the client service 101/201 based on the identity token associated with it and any configuration information provided by the client service 101/201 to secretless connection broker 102/202. For example, the authentication of client service 101/201 may involve verifying that the client service 101/201 is operating from an approved IP address, MAC address, domain, geographic location, etc. This information may be detected from the request by the client service 101/201, as discussed above. Further, the authentication may involve determining whether a set of privileges or access rights associated with the identity token is sufficient to access the requested access-protected network resource 106/208. Further, as discussed above, the authentication of client service 101/201 may be based on a blockchain-based authentication process performed by blockchain service system 205.

If in operation 403 a secret is successfully fetched by the secretless connection broker 102/202, process 400 may continue to operation 405, where the secretless connection broker 102/202 connects to the access-protected network resource 106/208. For example, in some embodiments, secretless connection broker 102/202 may open a secure communications channel (e.g., based on SSL, TLS, a secure shell tunnel, an IPIP tunnel, an IPSec tunnel, etc.) in which the client service 101/201 and the requested access-protected network resource 106/208 can directly communicate with each other. In some embodiments, the access-protected network resource 106/208 itself establishes the secure communications channel, following an authentication process based on the fetched connection credential. Further, in some embodiments, the secretless connection broker 102/202 further uses the fetched connection credential to log the requesting client service 101/201 into the requested access-protected network resource 106/208 (e.g., into an account).

Once a secure communication channel has been established in operation 405 (or in parallel with operation 405), process 400 may include an operation 406 of exchanging communications between the client service 101/201 and the access-protected network resource 106/208. This may occur in a variety of ways. For example, in some embodiments, the communications continue to flow through the secretless connection broker 102/202. For example, the secretless connection broker 102/202 may act as a proxy, or otherwise monitor and intercept communications, between the client service 101/201 and the access-protected network resource 106/208. In such embodiments, secretless connection broker 102/202 may perform address routing or rerouting (e.g., based on the IP address or other network address of the client service 101/201 and the access-protected network resource 106/208, through encapsulating and re-addressing packets, etc.). Further, where the client service 101/201 seeks to communicate with network resources other than the access-protected network resource 106/208, the secretless connection broker 102/202 may pass through (i.e., not reroute) the communications.

In the above embodiments, the secretless connection broker 102/202 may have control over exchanged communications (e.g., the ability to monitor, permit, block, reroute, etc.). In other embodiments, the secretless connection broker 102/202 may not receive the communications exchanged between the client service 101/201 and the access-protected network resource 106/208. In such an implementation, the client service 101/201 and the access-protected network resource 106/208 may utilize the secure communications channel that was created in operation 405 (e.g., based on SSL, TLS, a secure shell tunnel, an IPIP tunnel, an IPSec tunnel, etc.) to communicate with each other without passing communications through the secretless connection broker 102/202. In either configuration (i.e., whether the secretless connection broker 102/202 receives and reroutes exchanged communications, or does not receive exchanged communications), the authentication and log-in process may be transparent from the perspective of the client service 101/201, and potentially also transparent from the perspective of the access-protected network resource 106/208. In other words, the necessary connection credential may be supplied to the access-protected network resource 106/208, and communications between it and the client service 101/201 may occur as if the client service 101/201 directly provided the connection credential itself.

In some embodiments, connection credentials maintained by the authentication credential provider 105, blockchain service 205, or vault 104/204 may be rotated, replaced, or updated. For example, in some embodiments the connection credentials may be automatically rotated to new credentials upon every successful or attempted connection from a client service 101/201 to an access-protected network resource 106/208. Further, in some embodiments a security policy (e.g., implemented by authentication credential provider 105, blockchain service 205, or vault 104/204) may specify that connection credentials should be updated periodically (e.g., weekly, daily, etc.), based on certain levels of use (e.g., numbers of times of use, durations of use, etc.), based on certain levels of idleness or non-use (e.g., time since last use, average usage over time, etc.). When connection credentials are rotated, replaced, or updated, a corresponding listing, mapping, or directory of the connection credentials may be updated, such that the new connection credentials are linked to particular identity tokens. In this manner, a particular identity token may be associated with a current connection credential, and when the current connection credential is replaced with a new connection credential, the identity token will be associated with the new connection credential via the listing, mapping, or directory.

Accordingly, in an operation 407, process 400 may determine whether a connection credential corresponding to a particular identity token has been changed. If so, process 400 may cycle back to a previous operation (e.g., operations 402 or 403), so that the new connection credential may be obtained. If the connection credential has not changed, process 400 may continue with operation 406, where client service 101/201 is able to securely communicate with access-protected network resource 106/208. Consistent with operation 407, process 400 may detect changes to connection credentials during their non-use, or even during their use, and continue in order to allow communications to occur uninterrupted in operation 406.

In some embodiments, once the secure communication session between the client service 101/201 and the access-protected network resource 106/208 has terminated (e.g., due to disconnection, timeout, externally-forced termination, etc.), the secretless connection broker 102/202 itself may be automatically terminated. For example, in some embodiments the secretless connection broker 102/202 may be an application that is running in a virtualized manner in a cloud arrangement (e.g., as a virtual machine, container instance, serverless code, etc.). In such embodiments, the secretless connection broker 102/202 may be spun up on-demand (e.g., based on detection of the request in operation 401) and automatically terminated when the session between the client service 101/201 and the access-protected network resource 106/208 ends. Further, in other embodiments, the secretless connection broker 102/202 may be an application running (e.g., as an agent) on the same machine as a client service 101/201 itself, or at a proxy server remote from the client service 101/201. In such embodiments, secretless connection broker 102/202 may detect the termination of the session involving client service 101/201 and terminate its own execution automatically at that point.

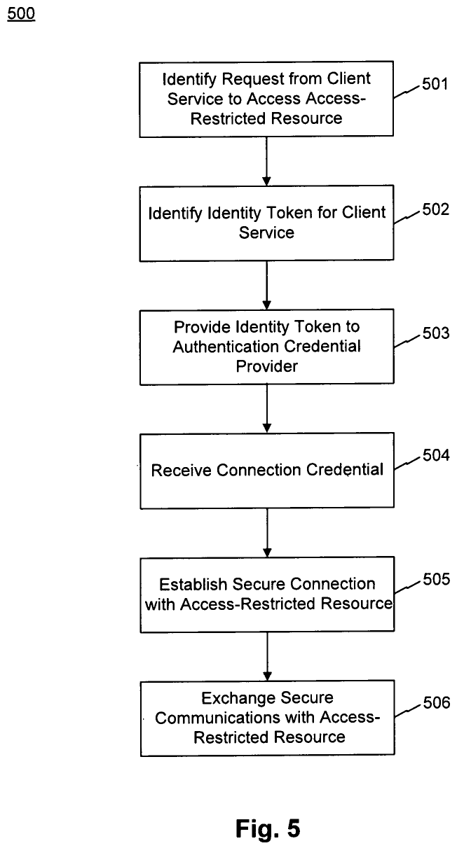

FIG. 5 is another flowchart illustrating a process 500 of secretless and secure communications with access-protected network resources. Consistent with above embodiments, process 500 may be performed by secretless connection broker 102/202 and/or other components of systems 100/200.

In an operation 501, process 500 may include identifying, at a secretless connection broker, a request from a client service to access an access-protected network resource. For example, as discussed above, the request may be identified based on the secretless connection broker receiving a request to communicate with the access-protected network resource, the secretless connection broker receiving a request to authenticate a user, application, or device associated with the client service, or through the access-protected network resource redirecting the request to the secretless connection broker. In such embodiments, the client service lacks information required for a connection with the access-protected network resource. For example, the client service lacks a connection credential required to communicate with the access-protected network resource. Instead, the connection credential may be accessed by the secretless connection broker, as discussed above.

Process 500 may further include an operation 502 of automatically identifying, based on the request identified in operation 501, an identity token uniquely associated with the client service. For example, as discussed above, an identity token uniquely associated with a user, application, or device of a client service may be stored in authentication credential provider 105, blockchain service 205, or vault 104/204. The identity token may be uniquely associated with the client service in terms of various different attributes, as discussed above, such as a unique name, network address, etc. Consistent with above embodiments, the identity token may be configured for enabling autonomous authentication of the client service using the identity token. For example, as discussed above, the secretless connection broker 102/202 may authenticate the client service based on whether the identity token matches attributes of the client service (e.g., a name or network address associated with the request in operation 501). Further, the secretless connection broker 102/202 may authenticate the client service by determining whether the requesting client service has privileges or permissions to access to requested access-protected network resource (e.g., based on reference to a network security policy, configuration file, etc.). Alternatively, the secretless connection broker 102/202 may authenticate the client service by determining whether the identity token matches a connection credential stored in authentication credential provider 105, blockchain service 205, or vault 104/204. In various embodiments, operation 502 may be similar to 402 of process 400.

Process 500 may further include an operation 503 of providing, from the secretless connection broker to an authentication credential provider, the identity token uniquely associated with the client service. For example, as discussed above, the secretless connection broker may provide the identified identity token to the authentication credential provider 105, blockchain service 205, or vault 104/204. In accordance with operation 503, the identity token may be compared to a listing, mapping, or directory of the authentication credential provider 105, blockchain service 205, or vault 104/204, which correlates between identity tokens and connection credentials. In some situations, a connection credential may be found that corresponds to the identified identity token, while in other situations no such connection credential may be found. If no connection credential is found, or if the client service is not authenticated based on its corresponding identity token, access to the requested access-protected network resource may be denied.

Process 500 may further include an operation 504 of receiving, from the authentication credential provider (e.g., 105 or 205), based on the identity token and conditional on successful authentication of the client service, a connection credential. As discussed above, the connection credential is provided for enabling the secretless connection broker to connect with the access-protected network resource on behalf of the client service as specified in the request. For example, the connection credential may be a secret (e.g., password, token, key, etc.) that is sufficient to authenticate the client service to the access-protected network resource to which the client service is seeking access. In accordance with operation 504, the connection credential is not made accessible to the client service. Instead, the connection credential is securely maintained by the authentication credential provider (e.g., 105 or 205) and may be fetched by the secretless connection broker on an on-demand and as-needed basis. Because the connection credential is not sent to the client service itself, if an attacker compromises the client service the attacker will not be able to thereby steal the connection credential. In various embodiments, operation 504 may be similar to operation 403 of process 400.

Process 500 further includes an operation 505 of establishing a secure connection, on behalf of the client service, with the access-protected network resource using the connection credential. For example, as discussed above, the secretless connection broker may establish a connection with the target access-protected network resource based on SSL, TLS, a secure tunneling protocol, etc. Alternatively, the access-protected network resource itself may establish the connection. In various embodiments, operation 505 may be similar to operation 405 of process 400.

Once the secure connection between the client service and the access-protected network resource has been established according to operation 505, in an operation 506 process 500 may include exchanging secure communications, on behalf of the client service, with the access-protected network resource through the secure connection. This may happen several different ways, as discussed above. For example, the secretless connection broker may establish the secure connection and then participate in communications by receiving, and rerouting communications between the client service and access-protected network resource. This may involve, for instance, the secretless connection broker modifying the network address (e.g., IP address) information within exchanged data packets, or re-encapsulating exchanged packets with new address information. Alternatively, the secretless connection broker may cease to be involved in exchanged communications after the secure connection between the client service and access-protected network resource is established. For example, the secretless connection broker may log the client service into an account at the access-protected network resource and provide it with network address information for the client service (or provide the client service with network address information for the access-protected network resource). Subsequently, the client service and access-protected network resource may communicate as if the client service had initially provided the connection credential to the access-protected network resource itself.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for secretless and secure communications with access-protected network resources, the operations comprising:
identifying, at a secretless connection broker, a request from a client service to access an access-protected network resource, wherein the client service lacks information required for a connection with the access-protected network resource;
automatically identifying, based on the request, an identity token uniquely associated with the client service for enabling autonomous authentication of the client service using the identity token;
providing, from the secretless connection broker to an authentication credential provider, the identity token uniquely associated with the client service;
receiving, from the authentication credential provider, based on the identity token and conditional on successful authentication of the client service, a connection credential for enabling the secretless connection broker to connect with the access-protected network resource on behalf of the client service as specified in the request, wherein the connection credential is not made accessible to the client service;
establishing a secure connection, on behalf of the client service, with the access-protected network resource using the connection credential; and
exchanging secure communications, on behalf of the client service, with the access-protected network resource through the secure connection.

2. The non-transitory computer readable medium of claim 1, wherein the secretless connection broker is configured to receive, from the client service, configuration information specifying one or more attributes of the secure connection with the access-protected network resource.

3. The non-transitory computer readable medium of claim 1, wherein the secretless connection broker is configured to control the exchanged secure communications with the access-protected network resource.

4. The non-transitory computer readable medium of claim 1, wherein the authentication credential provider is configured to rotate the connection credential to a new connection credential, and the secretless connection broker is configured to receive the new connection credential.

5. The non-transitory computer readable medium of claim 1, wherein the authentication credential provider is configured to rotate the connection credential each time the client service requests access to the access-protected network resource.

6. The non-transitory computer readable medium of claim 1, wherein the secretless connection broker is configured to pass through communications from the client service addressed to a network resource other than the access-protected network resource.

7. The non-transitory computer readable medium of claim 1, wherein once the secretless connection broker establishes the secure connection with the access-protected network resource, the secretless connection broker does not receive the secure communications with the access-protected network resource.

8. The non-transitory computer readable medium of claim 1, wherein the client service has a plurality of constituent identities, and the secretless connection broker is dedicated to a specific identity from the plurality of constituent identities.

9. The non-transitory computer readable medium of claim 1, wherein the secretless connection broker is automatically terminated upon termination of the client service.

10. The non-transitory computer readable medium of claim 1, wherein the connection credential is a one-time-use connection credential uniquely associated with the access request from the client service and the access-protected network resource.

11. The non-transitory computer readable medium of claim 1, wherein exchanging secure communications includes setting up a secure tunnel between the client service and the access-protected network resource.

12. The non-transitory computer readable medium of claim 1, wherein the secretless connection broker is an agent running on the same machine as the client service.

13. The non-transitory computer readable medium of claim 1, wherein the secretless connection broker is a proxy server located remote from the client service.

14. The non-transitory computer readable medium of claim 1, wherein the secretless connection broker is configured to open a local connection with an application associated with the client service.

15. A computer-implemented method for secretless and secure communications with access-protected network resources, the method comprising:
identifying, at a secretless connection broker, a request from a client service to access an access-protected network resource, wherein the client service lacks information required for a connection with the access-protected network resource;
automatically identifying, based on the request, an identity token uniquely associated with the client service for enabling autonomous authentication of the client service using the identity token;
providing, from the secretless connection broker to an authentication credential provider, the identity token uniquely associated with the client service;
receiving, from the authentication credential provider, based on the identity token and conditional on successful authentication of the client service, a connection credential for enabling the secretless connection broker to connect with the access-protected network resource on behalf of the client service as specified in the request, wherein the connection credential is not made accessible to the client service;
establishing a secure connection, on behalf of the client service, with the access-protected network resource using the connection credential; and
exchanging secure communications, on behalf of the client service, with the access-protected network resource through the secure connection.

16. The computer-implemented method of claim 15, wherein the identity token is securely stored on the secretless connection broker.

17. The computer-implemented method of claim 15, wherein the secretless connection broker is configured to store a plurality of different identity tokens for use in authenticating the client service to a plurality of different authentication credential providers.

18. The computer-implemented method of claim 17, wherein the plurality of different identity tokens are stored on a secure keyring of the secretless connection broker.

19. The computer-implemented method of claim 15, further comprising providing the connection credential to the access-protected network resource to establish the secure connection.

20. The computer-implemented method of claim 15, further comprising requesting that the authentication credential provider rotate the connection credential upon the termination of the secure connection.
